(19) United States
(12) Patent Application Publication
(10) Pub. No.: US 2012/0130924 A1
(43) Pub. Date: May 24, 2012

(54) SYSTEM AND METHOD FOR ANALYZING ENERGY USE

(76) Inventor: Patrick W. James, Rockwall, TX (US)

(21) Appl. No.: 12/951,653

(22) Filed: Nov. 22, 2010

(51) Int. Cl. G06F 17/00; G06F 19/00; G01W 1/00

(52) U.S. Cl. 705/412; 702/3

(57) ABSTRACT

Analyzing energy use comprises determining a location identifier associated with a site. Weather data associated with the site is determined according to the location identifier. Energy usage information associated with the site is determined. An energy metric for the site is calculated based on the weather data and the energy usage information. The energy metric comprises a selected one of a forecasted energy cost and a computed energy setting.

### TECHNICAL FIELD

This invention relates generally to the field of energy use and more specifically to a system and method for analyzing energy use.

### BACKGROUND

In recent years, technological advances have resulted in an increase in the number of devices used in residences and businesses. These devices generally consume energy. Using many devices and/or using devices that consume high levels of energy lead to high energy costs. Because energy costs are prone to fluctuate, it becomes difficult to budget for energy costs.

### SUMMARY OF THE DISCLOSURE

In accordance with the present invention, disadvantages and problems associated with previous techniques for analyzing energy use may be reduced or eliminated.

According to one embodiment of the present invention, analyzing energy use comprises determining a location identifier associated with a site. Weather data associated with the site is determined according to the location identifier. Energy usage information associated with the site is determined. An energy metric for the site is calculated based on the weather data and the energy usage information. The energy metric comprises a selected one of a forecasted energy cost and a computed energy setting.

Certain embodiments of the invention may provide one or more technical advantages. A technical advantage of one embodiment may be that energy users may forecast energy costs an arbitrary amount of time into the future. With the benefit of this knowledge, energy users may make decisions intelligently regarding the use of their devices that consume energy. Another technical advantage of one embodiment may be that energy users may update energy settings for the devices in their residence and/or business remotely. Still another technical advantage of one embodiment may be the ability to forecast energy costs for a specific device or group of devices.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates an embodiment of a system operable to analyze energy use at various sites.

FIG. 2 illustrates an embodiment of a server operable to facilitate determination of an energy metric.

FIG. 3 is a flow chart that illustrates a method for analyzing energy use to facilitate determination of an energy metric.

FIG. 4 illustrates an example embodiment of an interface operable to allow display and modification of energy metrics and energy settings.

### DETAILED DESCRIPTION OF THE DRAWINGS

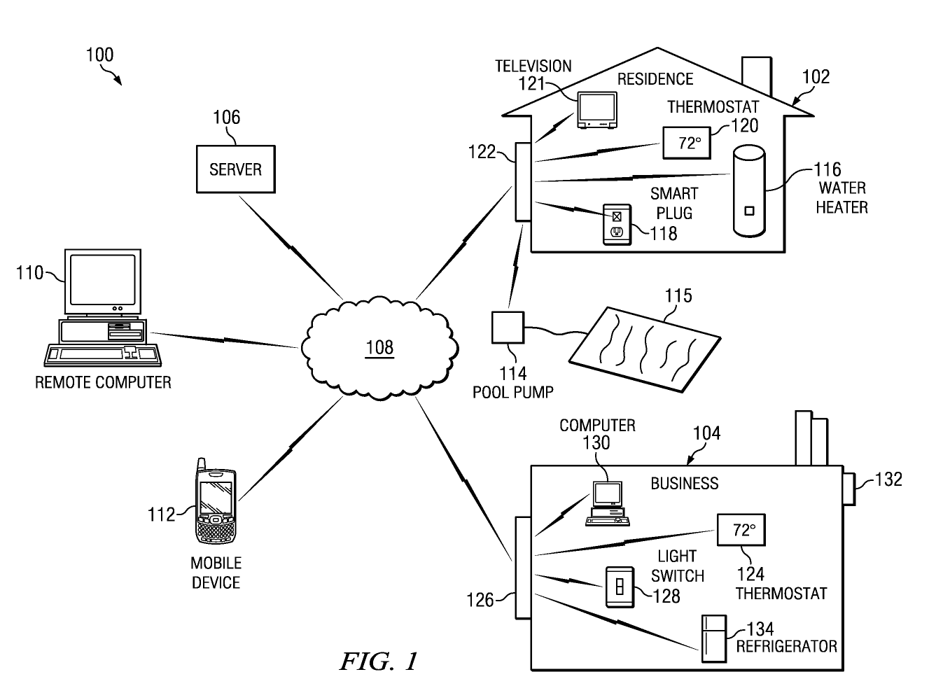

Embodiments of the present invention and its advantages are best understood by referring to FIGS. 1 through 4 of the drawings, like numerals being used for like and corresponding parts of the various drawings.

FIG. 1 illustrates an embodiment of a system 100 operable to analyze energy use at various sites. The analysis may comprise determining an energy metric for a site, such as a forecasted energy cost for the site or a computed energy setting for a device at the site. Sites may include, for example, residences 102 and businesses 104. The sites may communicate with a server 106 over a network 108, such that server 106 may facilitate determining an energy metric. Server 106 may communicate the results of its analysis through network 102 to a particular site and/or to a client, such as a remote computer 110 or mobile device 112. Certain embodiments of system 100 may determine an energy metric for individual devices or groups of devices instead of or in addition to determining an energy metric for a site.

Network 102 represents any suitable communication network. By way of example, network 102 may comprise all or a portion of one or more of the following: a public switched telephone network (PSTN), a public or private data network, a local area network (LAN), a metropolitan area network (MAN), a wide area network (WAN), a smart grid, a local, regional, or global communication or computer network such as the Internet, a wireline or wireless network, an enterprise intranet, other suitable communication link, or any combination of any of the preceding. Network 102 may include any combination of gateways, routers, hubs, switches, access points, base stations, and any other hardware, software, or a combination of the preceding.

System 100 may include any suitable site with devices that consume energy. Sites may comprise a complete building, such as a house in a residential neighborhood. A site may also consist of only a portion of a building, such as an apartment in an apartment building or a business that occupies a subset of all the floors in a building. A site may comprise a complex, such as a business that occupies multiple buildings. Additionally, a site may comprise a building and portions of the area surrounding the building, such as a house and the pool in its backyard. Other examples of sites include stadiums and city parks. A site may also comprise only a portion of any of the preceding. In this way, energy metrics may be determined for one or more rooms in a building or a predefined set of devices.

In the illustrated embodiment, system 100 includes residence 102 and business 104. Residence 102 represents living quarters for any suitable number of users. As non-limiting examples, residence 102 may be a house in a neighborhood or an apartment in an apartment complex. Residence 102 comprises one or more devices that consume energy provided by a utility company. The users in residence 102 may pay a fee to a utility company for the amount of energy residence 102 uses for a given time period. As such, an ability to predict and control the cost of energy use at residence 102 may prove useful to the users. The devices may have configurable energy settings. The value of these settings may affect the energy use at residence 102, which may affect the energy cost. The particular settings for devices may be used by server 106, for example, to calculate an energy forecast for residence 102. Alternatively, an appropriate set of energy settings may be calculated to achieve a targeted energy cost for residence 102.

Residence 102 may comprise any of a variety of devices that consume energy. For example, residence 102 may comprise lights, temperature control units, dishwashers, refrigerators, freezers, microwaves, televisions, computers, washers, dryers, and energy-consuming vehicles (such as an electric car that draws energy from an source that supplies residence 102 with energy). In certain embodiments, the devices at residence 102 include a pool pump 114, a water heater 116, a smart plug 118, a thermostat 120, and/or a television 121.

Pool pump 114 operates to facilitate filtration of a pool 115 on a periodic basis. Pool pump 114 has configurable energy settings that users of residence 102 may modify to operate pool pump 114. For example, pool pump 114 may have energy settings that control the time, frequency, and/or duration of operation of pool pump 114. Changing these energy settings may affect energy use at residence 102. For example, running pool pump 114 for longer durations on a highly frequent basis may produce a higher energy cost than running pool pump 114 for a short duration on an infrequent basis.

Water heater 116 operates to heat water in residence 102. Similar to pool pump 114, water heater 116 may have configurable energy settings that users of residence 102 may modify to operate water heater 116. For example, water heater 116 may have energy settings that control the temperature to which water is heated and/or whether the water heater turns off at a certain time or after a certain period of non-use. For example, water heater 116 may consume less energy if the appropriate energy setting is set to maintain water at lower rather than higher temperatures.

Smart plug 118 comprises any suitable hardware and software to facilitate energy delivery to any suitable device. In certain embodiments, a device may plug directly into smart plug 118. The smart plug 118 may then plug directly into a wall outlet in residence 102. Smart plug 118 may have configurable energy settings that control when energy is delivered from the wall outlet to the device physically coupled to smart plug 118. Smart plug 118 may allow users of residence 102 to control the amount of energy delivered to any device comprising a plug adapter. Therefore, the energy delivery to a device may be controlled even if the device does not have an appropriate configurable energy setting built directly into the device. For example, a generic lamp may be plugged into smart plug 118. A user may configure smart plug 118 to allow energy delivery to the lamp beginning at a specific time on weeknights for a particular duration of time. Other examples of devices that may use smart plug 118 include plug-in heat radiators, air conditioning units, or fan units.

Thermostat 120 comprises any suitable hardware and software to facilitate environmental control in all or a portion of residence 102. Thermostat 120 may be coupled to a heating, ventilating, and air conditioning (HVAC) system operable to adjust or maintain environmental conditions, such as temperature and humidity level. Thermostat 120 may have configurable energy settings. For example, thermostat 120 may be configurable to operate either under a cooling program or a heating program. The cooling program may operate to cool one or more rooms in residence 102 while the heating program may operate to heat one or more rooms in residence 102.

As another example of energy settings for thermostat 120, a day may be split into four different time periods: morning, daytime, evening, and night. A user may specify a temperature (also called a set-point) and a start time for each of the time periods. On each day, at the start time for each time period, thermostat 120 may turn on an HVAC system to reach the specified set-point and maintain that specified set-point at least until the start time for the next time period. Thermostat 120 may further allow configuration of start times with specified set-points for various days of the week. For example, thermostat 120 may have a certain configuration of settings for all weekdays but have a different configuration for weekend days.

Television 121 comprises any hardware and/or software suitable to present content, such as multimedia video and/or audio content, at residence 102. Television 121 may have configurable energy settings that users of residence 102 may modify to operate television 121. For example, television 121 may have energy settings that control brightness at which visually presentable content is displayed. Television 121 may consume less energy if the brightness is set to lower rather than at higher levels. As another example, television 121 may have energy settings that control the time at which the television operates. Television 121, for example, may be set to turn on to a certain music channel at a certain time of the day for certain days of the week. As will be described in more detail below, television 121 may operate as a client, which allows it to present and/or allow a user to input energy-related information about television 121 and/or any other devices at residence 102.

Gateway 122 comprises any suitable hardware and/or software to relay information between devices at residence 102 and other components of system 100 coupled to network 108. Using wired or wireless communication methods, gateway 122 may be coupled to one or more devices of residence 102. Gateway 122 may collect energy usage information, such as the amount of time a device has been running and the current energy setting for a device. In certain embodiments, gateway 122 may poll a device periodically (e.g., every fifteen minutes) to determine whether the energy settings of the device have changed. Gateway 122 may send the updated settings to server 106. Server 106 may store this information such that the next time server 106 calculates an energy metric associated with residence 102, server 106 will have access to the updated energy settings. This may be useful when a request to determine an energy metric associated with residence 102 comes from a source external to residence 102, such as remote computer 110, mobile device 112, or a module within server 106 itself.

Gateway 122 also may have certain “advanced” or “smart” metering capabilities in certain embodiments. Functioning as a smart meter, gateway 122 may have the ability to directly measure energy consumption at residence 102. Gateway 122 may communicate this information at regular intervals to server 106, which may be located at a utility company. Gateway 122 may transmit information such as a specific time that residence 102 consumed a particular amount of energy, the type of energy consumed (e.g., electric, gas, etc.), and/or the specific devices that consumed energy. Gateway 122 may directly make these measurements or may rely on the functionality comprised in devices at residence 102 to determine this information. Gateway 122 may compile this information in any suitable format and forward it to any suitable destination. Gateway 122 also may be a part of smart grid network or other network in which it operates with other gateways and/or smart meters located at other sites to send aggregated information to a suitable destination.

FIG. 1 also depicts business 104 as another example of a site in system 100. In certain embodiments, business 104 may use more energy to power its devices on average than residence 102. Business 104 may comprise any suitable device that consumes energy and has configurable energy settings. Business 104 may include any of the devices discussed above with respect to residence 102. Likewise, residence 102 may include the same types of devices located at business 104. As with the devices mentioned in connection with residence 102, the settings for devices at business 104 may be used to determine an energy forecast for business 104. Additionally, an appropriate set of computed energy settings may be calculated for devices located at business 104 to achieve a target energy cost. In the example depicted in FIG. 1, business 104 includes a thermostat 124, a gateway 126, a light switch 128, a computer 130, a temperature sensor 132, and a refrigerator 134. Thermostat 124 and gateway 126 may perform similar functions as discussed above with respect to thermostat 120 and gateway 122, respectively.

Light switch 128 operates to control all or a portion of lights used at business 104. Light switch 128 may have configurable energy settings that users at business 104 may modify to operate light switch 128. For example, light switch 128 may have energy settings that control the level of luminance for particular lights for specified times. To conserve energy, users at business 104 may choose to configure energy settings of light switch 128 such that lights of business 104 cease operation after a certain time or operate with a lower level of luminance.

Computer 130 comprises any hardware and/or software suitable to provide general computing functions of users of business 104. Computer 130 may have configurable energy settings that users of business 104 may modify to operate computer 130. For example, computer 130 may have energy settings that control brightness at which visually presentable content is displayed. Computer 130 may consume less energy if the brightness is set to lower rather than at higher levels. As another example, computer 130 may have energy settings that control the time at which the computer 130 operates. Computer 130, for example, may be set to operate at a low energy standby mode at a certain time of the day for certain days of the week. As a variation on this example, computer 130 may be set to enter standby mode after a certain period of non-use or when energy rates exceed a predefined limit. As will be described in more detail below, computer 130 may operate as a client, which allows it to present and/or allow a user to input energy-related information about computer 130 and/or any other devices at business 104.

Temperature sensor 132 comprises any hardware and/or software suitable to detect the ambient outside temperature at business 104. Temperature sensor 132 may collect temperature information, which may be stored for later use and/or transmitted to other devices, such as computer 130 and/or gateway 126. Information collected by temperature sensor 132 may be used for various purposes, such as for use in calculating an energy metric. The information may be stored as weather data for a specific site such that weather forecasts for the specific site may be more accurately predicted. For example, this information may aid in determining an offset or corrective factor to adjust a weather forecast, where the weather forecast applies generally to a larger geographic region.

Refrigerator 134 operates to cool the environment in its internal compartment to any suitable temperature. Refrigerator 134 may have multiple internal compartments set at different temperatures. For example, refrigerator 134 may have a freezer compartment and a refrigerator compartment where the freezer compartment operates to maintain a lower temperature than the refrigerator compartment. In another example, multiple compartments of refrigerator 134 operate to maintain the same temperature. Refrigerator 134 may have configurable energy settings that users at business 104 may modify to operate refrigerator 134. For example, refrigerator 134 may have energy settings that control the temperature and/or humidity for the various internal compartments. To conserve energy, users at business 104 may choose to configure energy settings of refrigerator 134 such that it maintains higher rather lower temperatures.

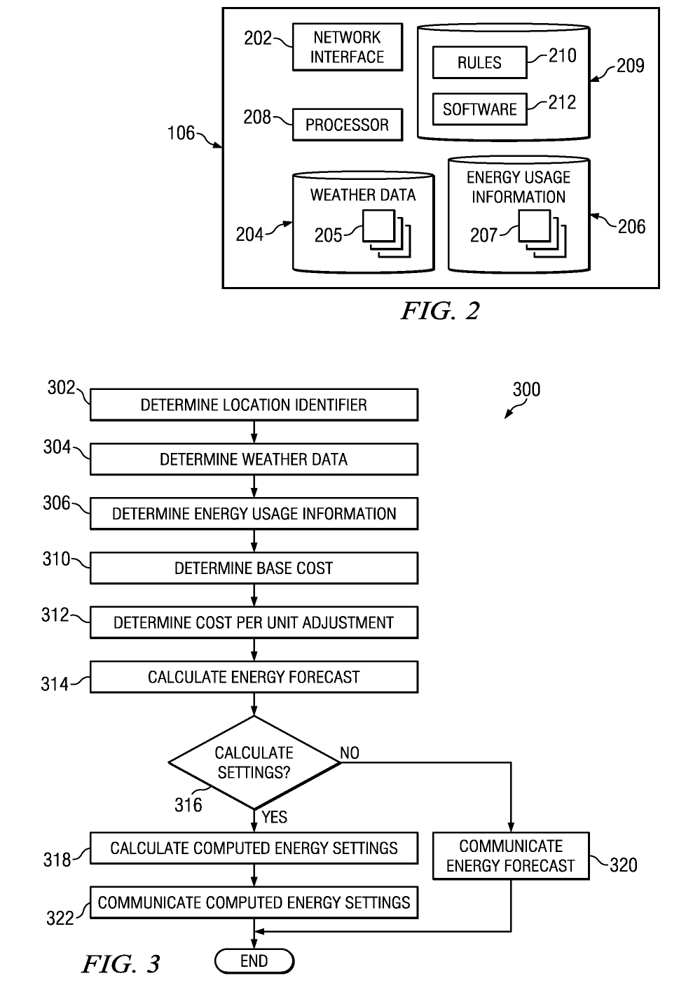

Server 106 includes any suitable hardware and/or software operable to facilitate analysis of energy use of sites in system 100. Server 106 may receive requests to calculate an energy metric for a site. Server 106 may access information associated with the devices for a particular site, such as their current energy settings, to calculate energy metrics. Server 106 also may determine data related to the weather located at or near a site to use in the calculation, such as the weather data for the next thirty days. This weather data may be based on historical measurements of the weather for a location. Additionally, weather data may be determined according to numerical predictions based on mathematical models of fluid dynamics and thermodynamics. Server 106 may use this weather data and energy usage information to determine an estimated energy cost for a site. Additionally, server 106 may determine an appropriate configuration of energy settings to achieve a targeted energy cost for a site. Server 106 may communicate these energy metrics to various clients in system 100, such as a suitable device located at a particular site, remote computer 110, or mobile device 112. In certain embodiments, server 106 may calculate an intermediate value of the energy metric. Server 106 may communicate this intermediate value such that another component in system 100 may calculate the final energy metric. In this way, the duties of calculating energy metrics in system 100 may be shared among components. The discussion below corresponding to FIG. 2 describes an embodiment of the components and operations of server 106.

Clients, such as remote computer 110 and mobile device 112, comprise any suitable hardware and/or software operable to initiate requests for analysis of energy use for a site and/or to receive the results. In certain embodiments, clients may comprise all or a portion of the functionality for determining an energy metric. Clients may communicate with server 106 or with residence 102 directly. Clients may comprise interfaces for allowing a user to determine or manipulate energy metrics for devices at a site. Any device located at any site with suitable hardware and/or software may function as a client. For example, television 121 at residence 102 and/or computer 130 at business 130 may function as a client. Alternatively, clients may be in a location remote from a site, such as remote computer 110.

Clients located remote from a site, such as remote computer 110 and mobile device 112, may include functionality for allowing a user to determine an energy metric associated with residence 102 from any location. This may allow, for example, a user remotely located from residence 102 for an extended period of time to set a target cost and change configurable settings remotely. In another example, an energy services company employee or other interested user may determine energy usage information for a plurality of sites. This may allow the user to determine forecasted energy costs using any suitable criteria, such as weather data, historical device performance, and/or device thermal properties. Alternatively, the utility company employee may set a target energy cost for multiple sites that are a part of a group. Using server 106, the utility company employee may determine computed energy settings that would achieve the overall target cost. In certain embodiments, system 100 may allow the utility company employee to remotely modify the energy settings of the sites in the group (on an individual or group level) to achieve the desired target cost.

In an example embodiment of operation, a user requests an energy metric for residence 102 from server 106 using remote computer 110. To obtain a forecasted energy cost for the next thirty days, the user communicates a current energy setting of one or more devices to server 106, such as a temperature setting on thermostat 120. The user also communicates energy usage information to server 106, such as the age, model number, historical performance information, and/or thermal properties of an HVAC unit located at residence 102. The user also communicates a location identifier to server 106, such as a zip code, city name, or a street name. In certain embodiments, server 106 may already have current energy settings, energy usage information, and/or a location identifier associated with residence 102 stored in local memory of server 106, such that remote computer 110 does not have to communicate all or a portion of that information. Server 106 uses the location identifier to access weather data associated with the location of residence 102. Server 106 calculates an energy forecast using the energy usage information and weather data and communicates that forecast to remote computer 110.

A user at remote computer 110 also may request computed energy settings for one or more devices at residence 102. The user communicates a target energy cost for a user-specified amount of time, such as the next thirty days. Server 106 determines a location identifier or energy usage information for residence 102 from any suitable source, such as the user at remote computer 110, local memory and/or memory remote to server 106, from one or more devices at residence 102, or from any combination of the preceding. Server 106 uses the location identifier to access weather data associated with the location of residence 102 for the next thirty days. Server 106 uses the energy usage information and weather data to calculate a configuration of computed energy settings suitable to achieve the targeted energy cost. Server 106 communicates the computed energy settings to the user at computer 110. The user may choose to remotely apply the configuration of computed settings to devices at residence 102.

In another example embodiment of operation, server 106 and a client both may perform calculations to determine an energy metric. Server 106 may calculate a baseline energy cost for a specified time period and/or a cost per unit deviation away from a standard value of an energy setting. A client may take this information and calculate an energy forecast with current energy settings of one or more devices at a site. Further, a client may calculate computed energy settings suitable to achieve a target energy cost using the target energy cost and the energy forecast corresponding to current energy settings.

Modifications, additions, or omissions may be made to system 100 without departing from the scope of the invention. The components of the systems and apparatuses may be integrated or separated. For example, certain embodiments of residence 102 may separate gateway 122 into multiple gateways, such that not every device is coupled to one gateway 122. Alternatively, gateway 122 may be removed from system 100 such that the devices at residence 102 may connect to network 108 directly. Moreover, the operations of the systems and apparatuses may be performed by more, fewer, or other components. For example, the functionality of server 106 may be integrated into remote computer 110, one or more devices at residence 102, gateway 122, or another component located at residence 102. These components may then have the ability to determine energy metrics for themselves on a per device basis instead of or in addition to metrics determined for an entire site. Additionally, operations of the systems and apparatuses may be performed using any suitable logic comprising software, hardware, and/or other logic.

FIG. 2 illustrates a particular embodiment of server 106 operable to facilitate determination of an energy metric within system 100. In certain embodiments, server 106 comprises a network interface 202, weather data repository 204, energy usage information repository 206, processor 208, and memory 209.

Network interface 202 communicates information with various components of system 100 through network 108. For example, network interface 202 receives requests to determine an energy metric for a site. Network interface 202 also may receive energy usage information or weather data. As another example, network interface 202 communicates computed energy metrics to a client, such as mobile device 112, or to a device located at residence 102. Network interface 202 represents any port or connection, real or virtual, including any suitable hardware and/or software that allow server 106 to exchange information with network 108, remote computers 110, the devices at any sites, or other components of system 100.

Weather data repository 204 operates as a memory module suitable to store weather data for various locations and provide that weather data to other components as needed. A memory stores information. A memory may comprise one or more non-transitory, tangible, computer-readable, and/or computer-executable storage media. Examples of memory include computer memory (for example, Random Access Memory (RAM) or Read Only Memory (ROM)), mass storage media (for example, a hard disk), removable storage media (for example, a Compact Disk (CD) or a Digital Video Disk (DVD)), and/or other computer-readable medium.

Weather data repository 204 may be configured to store and/or provide weather data 205 specific to a certain location as indicated by a location identifier. Weather data repository 204 may include historical weather data and may be updated on a periodic basis to include weather data for a specified time period into the future.

Weather data 205 may include, for example, historical temperature observations and future temperature predictions for various locations. Weather data 205 may include the number of Heating Degree Days (HDD) and/or Cooling Degree Days (CDD) associated with a particular time period. HDD reflects the amount of energy required to heat a site relative to the outside temperature. If the outside temperature exceeds a certain temperature (t_{H}), the site may not need heating. For example, if the outside temperature rises to 65 degrees Fahrenheit, a site may not require additional heating to reach a desired indoor temperature of 68 degrees Fahrenheit. The outside temperature may not need to reach the desired indoor temperature because, for example, additional heat at a site may emanate from people and/or devices. In some cases, t_{H} may equal the desired site or desired indoor temperature.

CDD reflects the amount of energy required to cool a site relative to the outside temperature. If the outside temperature falls below a certain temperature (t_{C}), the site may not need cooling. For example, if the outside temperature falls to 66 degrees Fahrenheit, a site may not require additional cooling to maintain a desired indoor temperature of 68 degrees Fahrenheit. In some cases, t_{C} may equal the desired site or desired indoor temperature. Note that t_{H} and t_{C} may be different temperatures. Weather data 205 may include HDD and/or CDD associated with historical time periods. Additionally, weather data 205 may include an estimated HDD and/or CDD for future time periods based on weather forecasts for future time periods.

Energy usage information repository 206 operates as a memory module suitable to store energy usage information 207 for one or more sites and provide that energy usage information to other components as needed. Energy usage information repository 206 may be configured to store and/or provide energy usage information 207 specific to a certain site according to a site identifier. A site identifier may be a street address or an account name, as non-limiting examples. Energy usage information 207 may come from a site, such as residence 102 or business 104. Energy usage information 207 may also be determined in any other suitable way. For example, an energy billing rate for a site may be accessed from an external database according to a site identifier. This energy billing rate may be stored in energy usage information repository 206 and retrieved as needed.

In addition to the energy billing rate, energy usage information 207 may include other types of data. For example, energy usage information 207 may include the type of energy provided to a site, such as gas and/or electricity. Energy usage information 207 may also include a base amount of energy use for a site. This may be, for example, an average amount of energy use in previous years. Alternatively, this base amount may represent an estimate for an energy use amount based on standard energy settings for the devices at a site. Energy usage information 207 may also comprise a site size, which may be an area of conditioned space. The site size may be the combined area for all or a portion of the rooms in the site under temperature control. The site size may be represented in any suitable units, such as square feet.

Energy usage information 207 may also comprise criteria associated with specific devices. Criteria may be any information associated with a device suitable to facilitate determination of an energy metric. For example, criteria may include device size, age, efficiency, model, or specific energy source (e.g., gas, electricity, solar, etc.). For certain devices, criteria may also include tonnage, seasonal energy efficiency ratio (SEER), annual fuel utilization efficiency (AFUE), and/or heating or cooling power.

Memory 209 comprises rules 210 and software 212 to facilitate the operation of server 106. Rules 210 include any suitable information that facilitates determination of an energy metric for a site. Rules 210, for example, may include specific equations for determining a forecasted energy cost or computed energy settings for one or more devices at a site. Rules 210, for example, may facilitate determining a forecasted energy cost by: calculating a base energy cost for a time period based on a standard energy setting, calculating a cost per unit change in an energy setting, calculating the difference between a forecasted energy cost based on the standard energy setting and a forecasted energy cost based on the current energy setting, and applying the difference to the base energy cost to determine the forecasted energy cost.

Software 212 represents any suitable set of instructions, logic, or code embodied in a computer-readable storage medium and operable to facilitate the operation of server 106. Software 212 may comprise functionality for general upkeep of server 106 in addition to specific functionality associated with determining an energy metric for a site. For example, software 106 may comprise instructions for sending an energy metric to remote computer 110 and/or mobile device 112. As another example, software 212 may comprise instructions for sending alerts (e.g., text messages, e-mails, phone calls) if certain conditions are met. For example, software 212 may include instructions for sending an alert if a targeted cost for a site has been exceeded or is predicted to be exceeded.

Processor 208 controls the operation and administration of server 106 by processing information received from the other components of server 106. Processor 208 includes any hardware and/or software that operate to control and process information. For example, processor 208 executes software 212 to control the operation of server 106. As another example, processor 208 may execute rules 210 to determine an estimate for the age of a device based upon the SEER of the device. This may be useful, for example, if the SEER is available but rules 210 require an age to determine the energy metric. Alternatively, processor 208 receives the age of the device from a remote location. Similarly, other information such as device size or a device's energy source may be derived or received from other components. Processor 208 may be a programmable logic device, a microcontroller, a microprocessor, any suitable processing device, or any suitable combination of the preceding.

Modifications, additions, or omissions may be made to server 106. For example, server 106 may be separated into to two or more components. In this example, the various components may share the duties of determining an energy metric by completing specific tasks according to rules 210. As a non-limiting example, one component may be responsible for determining the base costs for a time period while another component may use this base cost to determine a final value for the energy metric. Additionally, any suitable logic comprising software, hardware, other logic, or any suitable combination of the preceding may perform the functions of server 106.

FIG. 3 is a flow chart that illustrates a method 300 for analyzing energy use to determine an energy metric for a site for a specified time period into the future. Server 106 may perform the steps in method 300. In another example, software on a client, such as remote computer 110, may perform the steps in method 300. In still another example, server 106 and a client both may perform a portion of the steps of method 300 to facilitate determination of an energy metric.

Method 300 begins at step 302 where a location identifier, associated with a site is determined. In certain embodiments, the location identifier is a zip code. The zip code may be the zip code that corresponds to the city where the site is located. However, the zip code may correspond to another nearby location.

At step 304, weather data 205 associated with the location of the site is determined. For example, historical weather data and/or forecasted weather data is determined. The location identifier may be used to access weather data 205 in a database. As non-limiting examples, server 106 may accomplish this by accessing information in weather data repository 204 or from an external database.

Energy usage information 207 of a site is determined at step 306. Energy usage information 207 may include, for example, current energy settings for devices at the site along with other criteria associated with the devices. A user may input certain energy usage information 207 into a software interface on a client for use by various components to determine an energy metric. A client may send server 106 energy usage information 207 over network 108 and/or the client may use the information directly to make calculations. In certain embodiments, energy usage information 207 associated with a site may be determined from sources external to the site. For example, an energy billing rate for electricity may be retrieved from energy usage information repository 206 or any other suitable database.

At step 310, the base energy cost for a specified time period is determined for the site. For example, the specified time period may be the next thirty days. To determine base energy costs for the next thirty days, a yearly estimate of energy costs may first be calculated according to available information. An estimate of yearly base costs is determined using a configuration of standard energy settings. For example, a site with an HVAC may have a certain number of cooling hours per year. Estimates of the number of cooling hours per year may exist according to the location identifier. The estimate may be based on any suitable information, such as the number of cooling hours measured for a previous year for the location associated with the location identifier and/or the specific site. The estimate for yearly cooling energy use may be determined by:

$$yearly cooling cost = \frac{cooling hours * cooling output}{SEER} * EBR$$

where EBR represents energy billing rate. Cooling output is energy usage information typically represented in British Thermal Units per hour (BTU/h).

To determine yearly heating costs, heat output is determined as:

heat output per year=Ratio of HDD to Regional HDD*Regional Heat Load*Site Size

where Site Size represents the area of a site being heated. Depending on the heating source (e.g., gas, electric heat strip, or heat pump), the heat output per may be converted into heating energy consumed per year according to any suitable unit transformation. For example, if the heating source is gas, heating energy consumed per year is determined by:

$$heating energy consumed per year = \frac{heat output per year}{AFUE}$$

The yearly heating cost may be determined as:

yearly heating cost=heating energy consumed per year*EBR

Base costs for the next thirty days may then be calculated using a configuration of standard energy settings. This may be achieved, for example, by using weather data 205 determined in step 304. This may come in the form of CDD for cooling a site or HDD for heating a site. In certain embodiments, 65 degrees Fahrenheit is chosen as the base temperature for both HDD and CDD. The data acquired for HDD/CDD may not align exactly with the next thirty days. For example, a user may request an energy metric for the next thirty days during the middle of the month, such as July 15. The data acquired for CDD, for example, may be represented monthly such that there is only one CDD value for July, another for August, and so on. In this case, the total CDD for the next thirty days may be determined by taking a portion of the CDD for July proportional to the remaining days in July. That amount is combined with a portion of the CDD for August proportional to number of days in August falling within the next thirty days from the time the energy metric is requested. A similar calculation may be made for HDD if an estimate for monthly heating cost is required. The base heating cost for the next 30 days may be calculated as:

$$base heating cost for next 30 days = \frac{next 30 day HDD}{yearly HDD} * yearly heating cost$$

The base cooling cost for the next 30 days may be calculated as:

$$base cooling cost for next 30 days = \frac{next 30 day CDD}{yearly CDD} * yearly cooling cost$$

At step 312, a cost per unit to adjust the energy setting is determined. Note that this cost may be a savings depending on whether a particular current energy setting is greater or lower than a standard energy setting. In the example when thermostat 120 controls an HVAC, step 312 may determine the cost per degree adjustment away from a standard degree setting. Continuing with this example, for certain implementations, a user may realize a 1% decrease in cost by setting thermostat 120 up by one degree Fahrenheit for eight hours during periods where the HVAC would cool a site. Alternatively, a user may realize a 1% increase in cost by setting a thermostat down by one degree Fahrenheit for eight hours during periods where the HVAC would cool a site. As for heating, a user may realize a 1% decrease in cost by setting thermostay 120 down by one degree Fahrenheit for eight hours during periods where the HVAC would heat a site. Alternatively, a user may realize a 1% increase in cost by setting a thermostat up by one degree Fahrenheit for eight hours during periods where the HVAC would heat a site. The savings percentage may then be adjusted over a 24 hour period. The cost per degree adjustment may then be calculated as:

$$cost per degree adjustment = \frac{base cost for next 30 days}{savings \% for 1 degree change over 1 day}$$

At step 314, an energy forecast is calculated and returned if selected as the desired energy metric. For example, thermostat 210 may have a program with morning, daytime, evening, and night time periods as described in the discussion for FIG. 1. To determine a forecasted energy cost, method 300 may calculate the duration for each time period and calculate a set-point temperature difference from a baseline temperature (e.g., 70° F. for heating and/or 78° F. for cooling) for each time period.

Certain embodiments may adjust calculations depending on the actual energy consumption and actual energy settings observed at a site over a period of time in comparison to previously determined energy metrics and/or recommended actual energy settings. To correct for this, a personal performance modifier may be used to obtain more accurate energy metrics. For example, a site with configurable temperature settings may continuously deviate from its configured set-point levels by a certain offset or a certain percentage amount. In such a case, a personal performance modifier may be introduced into the calculations used by the method 300 to take into account observed empirical and/or behavioral data (e.g., an energy forecast may be multiplied by the personal performance modifier to obtain the final energy forecast). Personal performance modifiers or other corrective factors may take into account any other suitable conditions, such as whether an air filter needs to be changed and/or the date of the last equipment inspection or whether a coolant or other chemical leak exists. These conditions may be directly reported by users at a site through a service call. The affected devices themselves and/or gateways 122 or 126 may also report these conditions. In certain embodiments, the personal performance modifier may initially be set to 1.0. As more information is gathered for a particular site and/or devices within the site, the personal performance modifier may be changed.

At step 316, it is determined whether computed energy settings will be calculated. If no computed energy settings will be calculated, the energy forecast is communicated to a suitable destination in step 320. For example, server 106 may communicate the energy forecast to a client, such as remote computer 110 or to a device at a site. In certain embodiments, after step 320, method 300 ends.

If it is determined in step 316 that computed energy settings will be calculated, method 300 proceeds with step 318. At step 318, a target energy cost is used to determine computed energy settings. Server 106 may receive the target energy cost over network 108 from a user. In some embodiments, software on a client, such as remote computer 110, may determine computed energy settings after receiving an energy forecast computed with current energy settings.

In the example using thermostat 120 with an associated HVAC, a raw temperature adjustment suitable to achieve the target energy cost may be calculated as:

$$temperature adjustment = \frac{current energy forecost - target energy cost}{cost per degree adjustment}$$

where cost per degree adjustment may be calculated in step 312, for example. The current energy forecast may equal the value determined in step 314. If applying the adjustment results in a setting that thermostat 120 may be configured with, then the adjustment is applied and the computed energy setting is the result. In certain cases, the temperature adjustment may be a value that cannot be configured on thermostat 120, e.g. an adjustment that includes a fraction of a degree. The following paragraphs discuss one way of handling this issue.

If thermostat 120 is operating under a cooling program, a positive temperature adjustment indicates that the resulting computed energy settings should reduce energy costs. Therefore, the adjustment should be rounded up to the next highest degree. For example, a temperature adjustment of 1.1 or 1.9 degrees may be rounded up to 2 degrees to ensure that the computed energy settings will yield an energy cost less than the target energy cost. A negative temperature adjustment indicates that the resulting computed energy settings may increase energy costs. The temperature adjustment may be rounded up to the next highest degree to ensure that the resulting computed energy setting will yield an energy cost less than the target energy cost. For example, a temperature adjustment of −1.1 or −1.9 degrees may be rounded up to −1 degrees to ensure that the computed energy settings will yield an energy cost less than the target energy cost.

If thermostat 120 is operating under a heating program, a negative temperature adjustment indicates that the resulting computed energy settings should reduce energy costs. Therefore, the temperature adjustment should be rounded down to the next possible degree. For example, a temperature adjustment of −1.1 or −1.9 degrees may be rounded down to −2 degrees to ensure that the computed energy settings will yield an energy cost less than the target energy cost. A positive temperature adjustment indicates that the resulting computed energy settings may increase energy costs. The temperature adjustment should be rounded down to the next lowest degree to ensure that the resulting computed energy setting will yield an energy cost less than the target energy cost. For example, a temperature adjustment of 1.1 or 1.9 degrees may be rounded down to 1 degree to ensure that the computed energy settings will yield an energy cost less than the target energy cost.

Proposed changes to energy settings may be bounded such that they do not deviate beyond a defined margin from the current energy settings. For example, the defined margin for thermostat 120 may be plus or minus five degrees for its set-point energy settings. In other embodiments, there may not be a limit by which an energy setting may change.

In certain embodiments, the computed energy settings may be communicated to a suitable destination at step 322. For example, server 106 may communicate the computed energy settings to a client, such as remote computer 110 or to a device at a site. In another example, software on a client (e.g., remote computer 110, mobile device 112, and/or on a device located at a site) may communicate the computed energy settings by displaying them to a user through an interface on the client. For example, a user may receive the computed energy settings through an interface on thermostat 120. Method 300 may end after completion of step 322.

Modifications, additions, or omissions may be made to method 300 without departing from the scope of the invention. The methods may include more, fewer, or other steps. For example, step 310 may use any suitable time periods for its calculations.

Additionally, several calculations have been presented in association with heating and cooling energy metrics. These are only examples of calculating energy metrics. These calculations may be more refined with more specific information about the energy consumption at a particular residence. For example, the calculations may take into account the time of day for which an energy setting will apply. Temperature differences of the same amount may have quantifiable differences when used at different times of the day (e.g., decreasing the temperature setting by five degrees at Noon versus 8 p.m. in the evening). To implement this, method 300 may make use of a 24-hour model that indicates what effect a certain change in temperature may have on energy consumption during specific points of a day. There may be a 24-hour model for any suitable time period (e.g., for each quarter of a year, every six months of a year, and/or each month of the year). Method 300 may use the model that corresponds to the appropriate time period or time periods for which an energy metric is determined. This model may also be used to determine the duration for a temperature setpoint (e.g., 1, 2, or 3 hours).

Furthermore, different calculations may be used for the specific energy source being used (e.g., electric, gas, etc.). As another example, the device used for temperature control may depend on the actual outside temperature. A site that uses a heat pump for heating purposes may switch to using heat strips if the temperature falls below a certain level, such as 36° F. or 32° F. as non-limiting examples. In this case, the method may use different formulas or a combination of formulas to determine an appropriate energy metric.

Certain embodiments may include steps for sending and/or receiving a request to determine an energy metric. Additionally, steps may be performed in any suitable order. For example, a location identifier may be determined in step 302 after energy usage information is determined in step 304.

In another example embodiment involving an HVAC unit, method 300 may utilize weather data broken down into hourly units. An energy metric, such as a forecasted energy cost, may calculate forecasted energy cost for any suitable interval (e.g., fifteen-minute intervals). A forecast for a particular fifteen-minute interval may come from the corresponding hourly forecast. For each fifteen-minute interval, a forecast may be calculated based on the difference of the weather forecast and the temperature setpoint setting multiplied by the energy cost per unit (e.g., degree). To calculate the energy forecast for a time period (e.g., the next 30 days), the individual forecasts for each interval that make up the specified time period are added together. This may be added to a baseline forecast calculated according to any suitable method, such as those discussed above. Any of the recited steps may be adjusted by a personal performance modifier determined according to historical or observed performance of a particular device, site, and/or region.

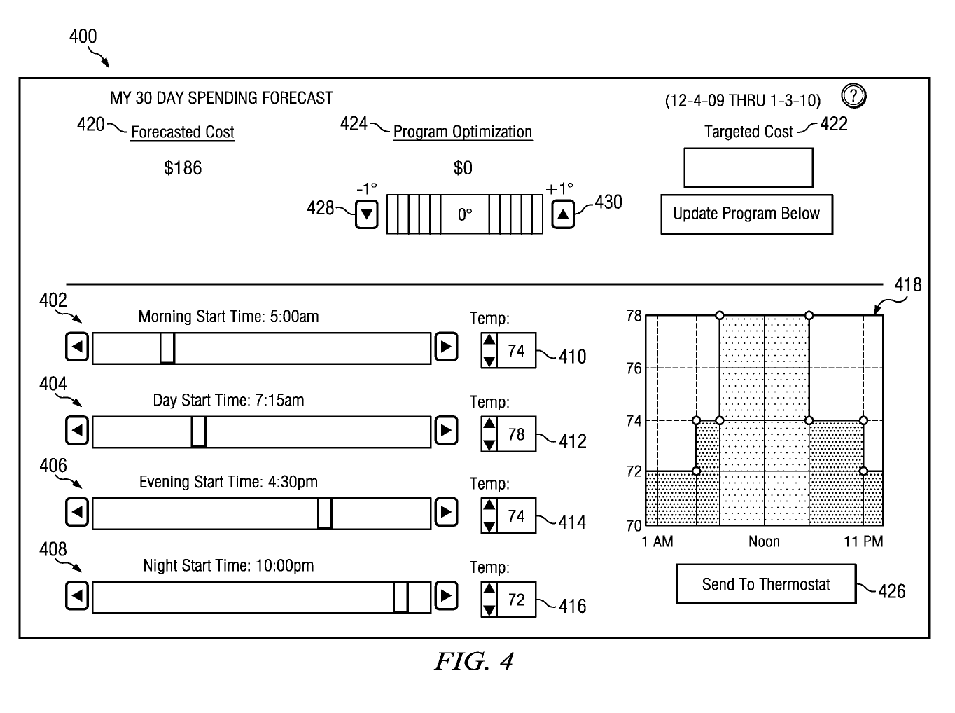

FIG. 4 illustrates an example embodiment of an interface 400 operable to allow display and modification of energy metrics and energy settings. Users may access interface 400 from any suitable client, such as remote computer 110 or mobile device 112, or a device located at a site. In certain embodiments, interface 400 displays and controls the configurable energy settings of thermostat 120. Interface 400 displays start time indicators 402, 404, 406, and 408, which correspond to set-point indicators 410, 412, 414, and 416, respectively. For example, start time indicator 402 and set-point indicator 410 indicate that beginning at 5:00 a.m. an HVAC will operate to maintain a temperature of 74 degrees at a site. An illustration 418 displays a graphical representation of time periods and their corresponding set-points.

A forecasted cost indicator 420 indicates a forecasted energy cost for the next 30 days using current energy settings of thermostat 120, for example. In the illustrated embodiment, the forecasted energy cost is $186. A user may enter a value into a targeted cost indicator 422 that represents a desired target cost. When the user enters a value into targeted cost indicator 422, computed energy settings associated with set-point indicators 410, 412, 414, and/or 416 may be calculated. The values displayed in set-point indicators 410, 412, 414, 416 as well as illustration 418 may change to indicate the computed energy settings. A program optimization indicator 424 displays the difference between the forecasted energy cost with current energy settings and the forecasted energy cost if the computed energy settings are to be used. If the user accepts the computed energy settings, the user may press an accept button 426 to send the computed energy settings to thermostat 120. Thermostat 120 will update its configuration to use the computed energy settings.

In certain embodiments, users may press degree changers 428 and 430 to determine how their energy forecast may be affected by changing set-points for all time periods by one degree. For example, pressing degree changer 428 calculates a forecasted energy cost using set-points reduced by one degree. In another example, pressing degree changer 430 calculates a forecasted energy cost using set-points increased by one degree. The cost or savings may be displayed in program optimization indicator 424. This may allow users to quickly determine how the energy forecast changes based on incremental changes in the energy settings. If the user wants to keep the changes, the user may press accept button 426 to send the new energy settings to thermostat 120. Thermostat 120 will update its configuration to use the new energy settings.

Modifications, additions, or omissions may be made to interface 400 without departing from the scope of the invention. For example, interface 400 may display indicators for both current energy settings and computed energy settings simultaneously. As another example, interface 400 may display energy settings for a different or an additional device, such as water heater 116. Additionally, operations of interface 400 may be performed using any suitable logic comprising software, hardware, and/or other logic.

A component of the systems and apparatuses disclosed herein may include an interface, logic, memory, and/or other suitable element. An interface receives input, sends output, processes the input and/or output, and/or performs other suitable operation. An interface may comprise hardware and/or software.

Logic performs the operations of the component, for example, executes instructions to generate output from input. Logic may include hardware, software, and/or other logic. Logic may be encoded in one or more tangible media and may perform operations when executed by a computer. Certain logic, such as a processor, may manage the operation of a component. Examples of a processor include one or more computers, one or more microprocessors, one or more applications, and/or other logic.

In particular embodiments, the operations of the embodiments may be performed by one or more non-transitory computer readable storage media encoded with a computer program, software, computer executable instructions, and/or instructions capable of being executed by a computer. In particular embodiments, the operations of the embodiments may be performed by one or more computer readable media storing, embodied with, and/or encoded with a computer program and/or having a stored and/or an encoded computer program.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the following claims.

What is claimed is:

1. A method of analyzing energy use, comprising:
determining a location identifier associated with a site;
determining weather data associated with the site according to the location identifier;
determining energy usage information associated with the site; and
calculating an energy metric for the site based on the weather data and the energy usage information, wherein the energy metric comprises a selected one of a forecasted energy cost and a computed energy setting.

2. The method of claim 1, further comprising receiving a request to calculate the energy metric for the site.

3. The method of claim 1, wherein the weather data comprises weather information associated with a future time period.

4. The method of claim 1, wherein determining energy usage information comprises receiving the energy usage information from a client.

5. The method of claim 1, wherein the energy usage information comprises one or more of the following:
an energy billing rate,
a site size, and
criteria associated with a device at the site.

6. The method of claim 5, wherein the criteria associated with the device at the site comprises one or more of the following:
a device size;
a device age;
a device efficiency;
a device model;
a device energy source; and
a device usage history.

7. The method of claim 1, wherein the energy metric comprises a forecasted energy cost and calculating the forecasted energy cost comprises:
determining a base cost for a time period;
determining an adjustment cost for the time period, wherein the adjustment cost comprises a cost per unit deviation away from a standard setting of a device at the site; and
calculating the forecasted energy cost according to the base cost and the adjustment cost.

8. The method of claim 1, wherein the energy metric comprises a computed energy setting and calculating the computed energy setting comprises:
determining a target energy cost;
calculating the computed energy setting according to the weather data such that an estimated energy cost of the site is less than or equal to the target energy cost.

9. The method of claim 1, further comprising communicating the energy metric to a client.

10. A system for analyzing energy use, comprising a processor operable to:
determine a location identifier associated with a site;
determine weather data associated with the site according to the location identifier;
determine energy usage information associated with the site; and
calculate an energy metric for the site based on the weather data and the energy usage information, wherein the energy metric comprises a selected one of a forecasted energy cost and a computed energy setting.

11. The system of claim 10, the system further comprising a network interface operable to receive a request to calculate the energy metric for the site.

12. The system of claim 10, wherein the weather data comprises weather information associated with a future time period.

13. The system of claim 10, the system further comprising a network interface operable to receive the energy usage information from a client.

14. The system of claim 10, wherein the energy usage information comprises one or more of the following:
an energy billing rate,
a site size, and
criteria associated with a device at the site.

15. The system of claim 14, wherein the criteria associated with the device at the site comprises one or more of the following:
a device size;
a device age;
a device efficiency;
a device model;
a device energy source; and
a device usage history.

16. The system of claim 10, wherein the energy metric comprises a forecasted energy cost and the processor is further operable to:
determine a base cost for a time period;
determine an adjustment cost for the time period, wherein the adjustment cost comprises a cost per unit deviation away from a standard setting of a device at the site; and
calculate the forecasted energy cost according to the base cost and the adjustment cost.

17. The system of claim 10, wherein the energy metric comprises a computed energy setting and the processor is further operable to:
determine a target energy cost;
calculate the computed energy setting according to the weather data such that an estimated energy cost of the site is less than or equal to the target energy cost.

18. The system of claim 10, the system further comprising a network interface operable to communicate the energy metric to a client.

19. A non-transitory computer readable storage medium encoded with instructions for analyzing energy use, the instructions when executed operable to:
determine a location identifier associated with a site;
determine weather data associated with the site according to the location identifier;
determine energy usage information associated with the site; and
calculate an energy metric for the site based on the weather data and the energy usage information, wherein the energy metric comprises a selected one of a forecasted energy cost and a computed energy setting.

20. The non-transitory computer readable storage medium of claim 19, the instructions when executed further operable to facilitate receiving a request to calculate the energy metric for the site.

21. The non-transitory computer readable storage medium of claim 19, wherein the weather data comprises weather information associated with a future time period.

22. The non-transitory computer readable storage medium of claim 19, the instructions when executed further operable to facilitate receiving the energy usage information from a client.

23. The non-transitory computer readable storage medium of claim 19, wherein the energy usage information comprises one or more of the following:
an energy billing rate,
a site size, and
criteria associated with a device at the site.

24. The non-transitory computer readable storage medium of claim 23, wherein the criteria associated with the device at the site comprises one or more of the following:
a device size;
a device age;
a device efficiency;
a device model;
a device energy source; and
a device usage history.

25. The non-transitory computer readable storage medium of claim 19, wherein the energy metric comprises a forecasted energy cost and the instructions when executed further operable to:
determine a base cost for a time period;
determine an adjustment cost for the time period, wherein the adjustment cost comprises a cost per unit deviation away from a standard setting of a device at the site; and
calculate the forecasted energy cost according to the base cost and the adjustment cost.

26. The non-transitory computer readable storage medium of claim 19, wherein the energy metric comprises a computed energy setting and the instructions when executed further operable to:
determine a target energy cost;
calculate the computed energy setting according to the weather data such that an estimated energy cost of the site is less than or equal to the target energy cost.

27. The non-transitory computer readable storage medium of claim 19, the instructions when executed further operable to facilitate communicating the energy metric to a client.
